(19) United States
(12) Patent Application Publication
(10) Pub. No.: US 2002/0161935 A1
(43) Pub. Date: Oct. 31, 2002

(54) System and method for dynamically adding management information base object

(76) Inventor: James Blaisdell, Oakland, CA (US)

Correspondence Address: Oleg F.Kaplun, Fay Kaplun & Marcin, LLP, 100 Maiden Lane, 17th Floor, New York, NY, 10038, US

(21) Appl. No.: 09/845,574

(22) Filed: Apr. 30, 2001

(51) Int. Cl. G06F 9/44

(52) U.S. Cl. 709/331

(57) ABSTRACT

A software package comprising a variable describing a state of a device, the variable having an assigned name, a mapping module including a mapping between the assigned name and a routine, wherein the routine accesses the variable and a dynamic receiving module receiving and storing, without recompiling the software package, a correlation between a common name for the variable and the assigned name, a request, including the common name of the variable being fulfilled by consulting the stored correlation. Further, a software package operating on a device comprising a reading module to read software code in a file, the software code including a correlation between a common name and an assigned name for a variable and a dynamic correlation module receiving the correlation from the reading module and storing, without recompiling the software package, the correlation.

### BACKGROUND INFORMATION

There are many types of computer networks, for example, Local-Area Network (LANs) and Wide-Area networks (WANs). In a LAN, computers are connected within a local area, for example a home or office. A LAN in a home or small office may interconnect a few computers, whereas in the case of a large office or industrial complex, the LAN may include hundreds or even thousands of interconnected computers. In a WAN, the interconnected computers are generally farther apart and are connected via telephone communication lines, radio waves, or other means of communication.

The internet is a network of computers that are linked together via a communication network. Networks, including the internet, allow users to exchange information in the form of data, application programs, etc. Additionally, a network is not limited to traditional computing devices, but may also include other types of hardware devices and information services, for example, embedded devices. An embedded device is any piece of hardware which contains a microcontroller allowing it to communicate with a network host. Common examples of embedded devices include cellular phones and hand held electronic devices.

When a computing device communicates with a network host, information is being passed back and forth via data packets formatted with a protocol (e.g. Transmission Control Protocol/Internet Protocol, TCP/IP). The format of the information within the data packet may be, for example, Wireless Access Protocol (WAP), Web Clipping, Compact HyperText Markup Language (HTML) or standard HTML using a wireless modem. For example, when designing a web page, programmers may use HTML code to assign appropriate functions to the page. The HTML code is then read by a connected computing device, e.g. a web browser on a server, and the functions requested by the page will be sent back to the browser, and displayed accordingly.

### SUMMARY

A software package comprising a variable describing a state of a device, the variable having an assigned name, a mapping module including a mapping between the assigned name and a routine, wherein the routine accesses the variable and a dynamic receiving module receiving and storing, without recompiling the software package, a correlation between a common name for the variable and the assigned name, a request, including the common name of the variable being fulfilled by consulting the stored correlation. Further, a software package operating on a device comprising a reading module to read software code in a file, the software code including a correlation between a common name and an assigned name for a variable and a dynamic correlation module receiving the correlation from the reading module and storing, without recompiling the software package, the correlation.

### BRIEF DESCRIPTION OF DRAWINGS

FIG. 1 shows an exemplary communication network on which the present invention may be implemented;

FIG. 2 shows an exemplary SNMP console working in conjunction with SNMP agents according to the present invention;

FIG. 3 shows an example of an embedded device having a MIB table to correlate common names for the MIB objects with the OIDs for those MIB objects according to the present invention;

FIG. 4 shows an exemplary web page as displayed by a browser;

FIG. 5 shows an example of a software system 100 on embedded device 45 to implement the present invention;

FIG. 6 shows an exemplary process for adding a MIB object correlation definition to a MIB table according to the present invention;

FIG. 7 is an exemplary process for handling common names of MIB objects by a MIB table according to the present invention;

FIG. 8 is an exemplary process for handling post operations on MIB objects from a user displaying a web page according to the present invention.

### DETAILED DESCRIPTION

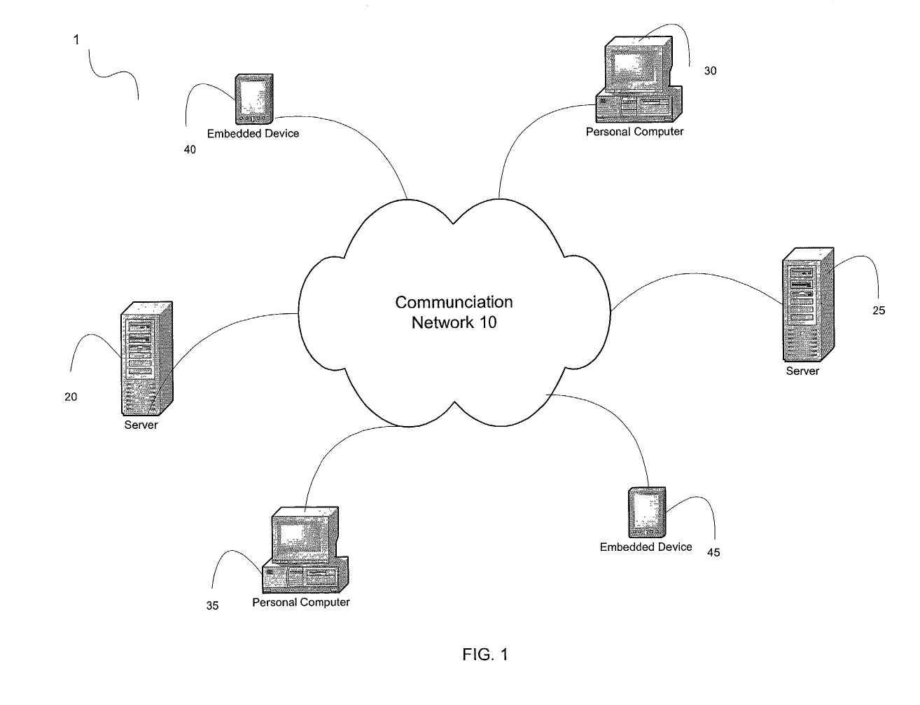

The present invention may be further understood with reference to the following description and the appended drawings, wherein like elements are provided with the same reference numerals. Initially, referring to FIG. 1 there is an illustrated exemplary network 1 on which the present invention may be implemented. Network 1 includes servers 20 and 25, personal computers (PCs) 30 and 35, and embedded devices 40 and 45. Each of the devices 20-45 is connected to communication network 10 (e.g. the internet). Those skilled in the art will understand that network 1 is only exemplary and the network 1 may include a variety of computing devices, arranged in a variety of configurations. The communication network 10 allows the connected devices 20-45 to exchange information (e.g. files, web pages, etc.). For example, PC 30 may request information from embedded device 40 in order to display a web page. One manner the information for a web page may be transmitted is through an exchange of HTML code. HTML is the page description language used to format pages for viewing via a web browser at the receiving station. As previously discussed, the HTML code is sent in the form of data packets. Embedded device 40 receives the request from PC 30 and sends back the requested information to PC 30. When PC 30 receives the information in the form of HTML code, PC 30 translates the code (e.g. via a web browser) and the web page is displayed on the monitor of PC 30.

When network 1 is connected, the various network hardware devices 20-45 may begin exchanging data packets. This communication is controlled via a protocol which specifies a common set of rules for packet format and packet flow. This protocol is implemented via networking hardware and/or software which is included in various network hosts which may include the connected hardware various devices 20-45. The network software controls the flow of packets, including the packet format and translations. Communication with certain network applications, such as Spanning Tree Protocol (STP) and Simple Network Management Protocol (SNMP) are also a function of the underlying network software.

One common protocol is the TCP/IP protocol suite. The TCP/IP protocol suite includes many different protocols, including SMTP (Simple Mail Transfer Protocol) and FTP (File Transfer Protocol). In general, TCP handles packet flow between devices and systems and IP handles the addressing of packets. In a network that uses IP, the network devices are identified by unique numbers which are known as IP addresses. These IP addresses allow the data packets to be routed or switched to the correct devices.

For example, server 20 on network 1 may receive a request for a data packet from PC 30, also connected to network 1. The PC 30 will have a unique IP address and therefore server 20 will know where to send the data packet. This destination address will be added or encoded on the data packet and the network software will send the data packet to the destination address, in this case, PC 30. PC 30 will also have TCP resident on its hardware and will be able to manage the exchange of information with the specific IP addresses. Those skilled in the art will understand that different network protocols perform addressing in different manners and that data packets may be encoded with more information than just the destination address, for example, the source address, protocol type, etc. The present invention may be implemented on any network regardless of the manner of addressing or encoding of the data packets.

Another example of network software sending data packets through the network is when PC 35 requests a web page for display on its monitor from embedded device 40. PC 35 may have, for example, a web browser that generates a request of a particular web page. PC 35 may operate an Internet browser such as Microsoft Internet Explorer®, Netscape Navigator® or other web browsing software. The internet browser software operated by PC 35 will transmit a request to embedded device 40. The request is in the form of a data packet or packets that include a destination address for the request, for example, embedded device 40 and a source address, for example PC 35, so the destination station can respond to the requesting station. The data packet request is encoded by the network software and transmitted via communication network 10 to embedded device 40. The request is processed by embedded device 40, which then sends a response to PC 35. The requested information is sent back in the form of data packets having a destination address the same as the original source address in the request (e.g. PC 35). PC 35 receives the data packets and processes the requested information via the web browser, and the web page is displayed on the monitor.

SNMP is a protocol framework which makes network management of multiple network devices possible. SNMP enables a system administrator to simultaneously manage a vast number of network devices through an external console, a “hub” on which the system administrator can access all of the network devices connected to it. The management by the system administrator is accomplished by the manipulation of a Management Information Base (“MIB”) containing objects (“MIB objects”) residing on each individual network device. MIB objects consist of a series of variables which describe the state of the device. The system administrator, through the SNMP console, may monitor and/or alter the MIB objects on any network device, thereby controlling the behavior of the device.

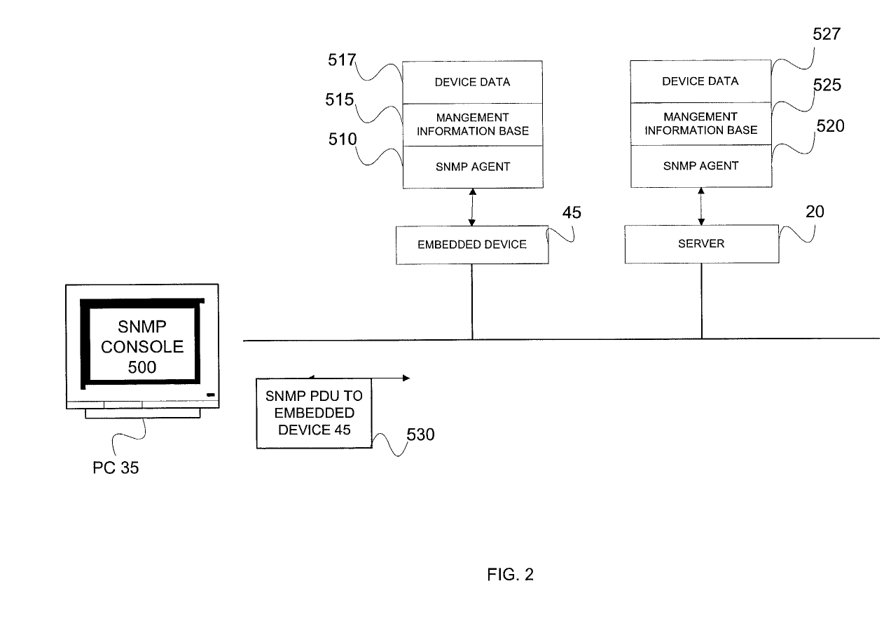

FIG. 2 is an example of an SNMP console 500 working in conjunction with the SNMP agents 510 and 520 (which are in this case software applications running on embedded device 45 and server 20, respectively). In this example, PC 35 acts as SNMP console 500, while other network devices (i.e., embedded device 45 and server 20) may be manipulated from SNMP console 500. Embedded device 45 has SNMP agent 510, MIB 515 and device data 517. Server 20 has SNMP agent 520, MIB 525 and device data 527. SNMP console 500 manipulates the devices MIB objects by sending out SNMP Protocol Data Units (“PDUs”). Each PDU encodes within it a list of the relevant MIB objects and values, if appropriate. FIG. 2 shows an example of an SNMP PDU 530 being sent from SNMP console 500 to embedded device 45. When the PDU arrives at embedded device 45, SNMP agent 510 parses out the list of objects and consults the list in MIB 515 about the objects contained in the PDU. The parsing of the PDU to get the list of MIB objects may be accomplished through various known manners such as through the use of the Structure of Management Information (“SMI”) standard.

All MIB objects are assigned an object identifier (“OID”), which makes each MIB object universally recognizable and unique. OIDs are usually represented as a dotted string (i.e. 1.2.3.4). The OIDs are defined in the Request for Comments (“RFC”) and are guaranteed to be unique across all networks in order to ensure that different entities do not conflict. For example, 1.3.6.1.2.1.1.5 is the OID for the MIB object sysName. Since the OIDs are standard, both the SNMP console 500 and the SNMP agent 510 on embedded device recognize the list of MIB objects that are transmitted via the PDU. Thus, if a system administrator desires to get the value for sysName, SNMP console 500 would send out a get PDU with the OID 1.3.6.1.2.1.1.5 encoded within it. The SNMP agent 510 would parse through the PDU to get the OID and consult MIB 515 which is a set of mappings between the MIB objects and the appropriate get or set routines which are used to provide access to the data. Depending on the nature of the request, the SNMP agent 510 then calls either the get or set routine associated with the MIB object. Similarly, SNMP agent 510 must send a PDU back to SNMP console 500 with the information requested in the PDU sent by SNMP console 500. The ability of each network device to recognize the MIB objects is important for SNMP to perform its function. MIB objects access the real device data (e.g., device data 517 and 527) in order to control the network device.

In addition to the system administrator accessing the MIB objects via SNMP console 500, other applications may require access to the device data (e.g., device data 517 and 527) through MIB objects in MIB 515 and 525. For example, embedded device 45 may host a web page which consists of HTML code and references to MIB objects. These references to MIB objects will be described in greater detail below. A client, for example, another device on the network such as server 20, may access the web page hosted by embedded device 45. When server 20 displays the web page on its monitor it may see the underlying device data 517 of embedded device 45 in the proper location as programmed by the developer of the web page. As previously described, MIB objects are identified by OIDs which are numeric strings. Such numeric strings may be difficult to remember and burdensome to program each time they are needed. For example, 1.3.6.1.2.1.1.518.0.2.4.730 is the OID a developer would insert to run the function of authenticating a user ID on an account. Thus, it may be helpful to substitute a series of letters or abbreviations which may be associated with the function carried out by the command and which may be easily remembered and recognized by human programmers.

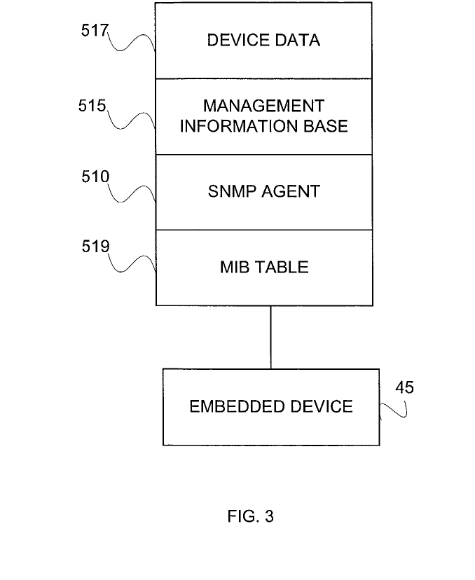

FIG. 3 shows an example of embedded device 45 having a MIB table 519 to correlate common names for the MIB objects with the OIDs for those MIB objects. The functions of OIDs may be assigned simple abbreviations rather than an entire English name because memory space in devices (e.g., embedded devices) may be limited. MIB table 519 is compiled with the software system loaded onto embedded device 45. Thus, when a developer wants to embed a command accessing a certain MIB object in MIB 515, the developer may use the common name for that function rather the OID. MIB table 519 may correlate the common name with the OID and pass it to SNMP agent 510 to access the correct MIB object. For example, if a developer wants a web page to include a login screen that authenticates a user ID, the developer may use the common name “AUTH” to perform the function rather than the complete OID of 1.3.6.1.2.1.1.518.0.2.4.730. When MIB table 519 sees the common name “AUTH”, it substitutes the correct OID so SNMP agent 510 gets the correct MIB object. One manner of substituting the correct OID may be for MIB table 519 to generate an internal PDU that is passed to SNMP agent 510. The internal PDU may then be parsed by SNMP agent 510 and the MIB object may be accessed from MIB 515 as described previously. It may also be possible to include logic in MIB table 519 so that it may access MIB 515 directly, bypassing SNMP agent 510. The logic to incorporate such a feature may include an SNMP abstraction layer so that MIB table 519 may mate with a variety of SNMP stacks and SNMP table logic.

As described above, when the device data 517 associated with the particular MIB object is sent out of SNMP agent 510, it is formatted, for example, as a PDU. MIB table 519 may receive this PDU and reformat it into, for example, text which is suitable for viewing via HTML or some other format that is compatible with the code that is being streamed out of the device.

MIB table 519 is additional data which needs to be stored on the device (e.g., embedded device 45). There may be hundreds of MIB objects stored on each device and storing the correlation for each of these MIB objects may be a burden on the system resources (e.g., system memory). Thus, system administrators and developers attempt to limit the amount of system memory that is used by the underlying software such as MIB table 519. One manner of saving resources is to not include all the common names for each MIB object contained in MIB 515. The system administrator or developer may select those common names for MIB objects which will likely be used most frequently to include in MIB table 519 and skip those common names for MIB objects which will not likely be used. However, if a common name is used which is not in MIB table 519, the system may not display the information.

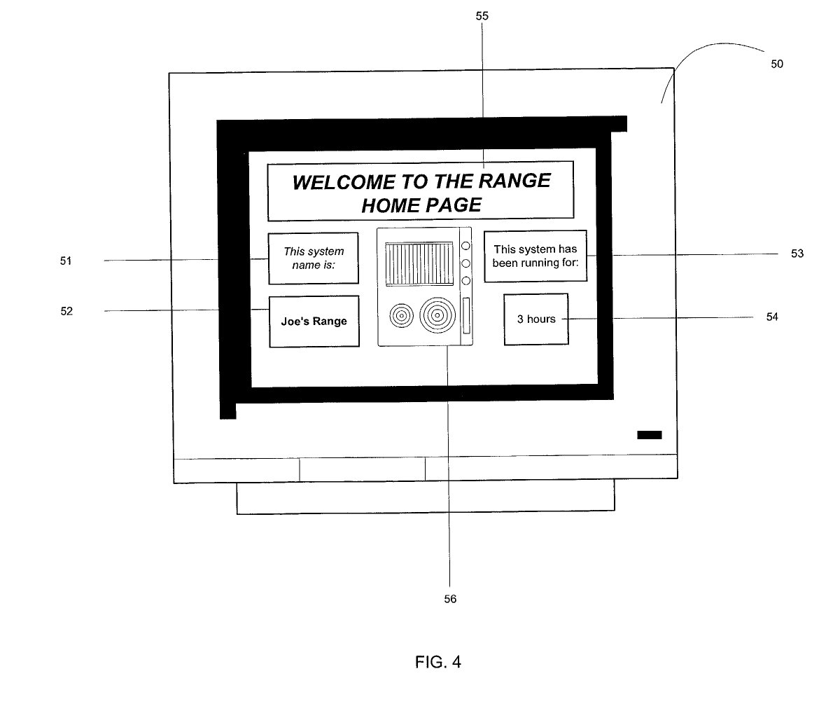

FIG. 4 is an example web page 50 that may be displayed on the monitor of PC 35 once the information is received from embedded device 45. Referring to FIG. 1, PC 35 and embedded device 45 are connected via communication network 10 (e.g., the Internet). The user of PC 35 desires access to the web page 50 hosted by embedded device 45 and sends a request via communication network 10. Web page 50 is transmitted from embedded device 50 via communication network 10 to PC 35 which may display web page 50 via its web browser. Referring back to FIG. 4, web page 50 may contain text blocks 51-55 and picture block 56. In this example, embedded device 45 may be a kitchen range. The user of PC 35 may desire remote access to range 45 for a variety of reasons, for example, to turn off the range if it was accidently left on after the homeowner left, to preheat the range prior to the homeowner arriving, general management of the range, etc. The developer of web page 50 may develop the page in a language readable by a web browser, for example, HTML. Each of the features displayed in web page 50 correlate to codes in the programming of web page 50. For example, the HTML code for block 55 may appear as: <H2><I><B>WELCOME TO THE RANGE HOME PAGE</B></I></H2>. In reading this, the browser of PC 35 may understand <H2>to mean “header” and will center the text between the open header indicator <H2>and the close header indicator </H2>. Similarly, <I>may mean “italics” and <B>may mean “bold” such that the text between the corresponding open and close indicators will be appropriately bolded and italicized when displayed by the web browser. When this string of HTML code is received by PC 35, it may display “WELCOME TO THE RANGE HOME PAGE” in text block 55.

In addition to the pre-set text on the web, the developer of web page 50 may choose to embed calls to the device data 517 of embedded device 45. For example, text boxes 51 and 53 are standard text boxes displaying pre-set text input by the developer. However, text boxes 52 and 54 may be links to device data 517 through MIB objects in MIB 515. Referring to text box 52 which displays the system name “Joe's Range,” the HTML code for this text box may be in the form:

<INPUT TYPE=“text”SIZE=“20”NAME=“sysName”VALUE=“$%sysName#$”>

This HTML code is a form element that is used to describe a one-line text box which are common elements in web-based management because they allow the end-user (e.g., the user of PC 35) to read and modify strings. In this example, the string displayed in text box 52 will be the system name. Those of skill in the art will understand that the present invention is not limited to this type of form element, other elements such as checkboxes, radio buttons, select boxes, etc. may be used. Similarly, the present invention is not limited to HTML coding on the web page, any manner of specifying calls to device data may be used in the present invention.

In the example above, the developer wanted to display the system name which is device data 517 that may be accesses through a MIB object in MIB 515. The OID of the function of system name is 1.3.6.1.2.1.1.5, but instead of coding this into the HTML code, the developer used the common name “sysName.” If MIB table 519 contains, the correlation between “sysName” and the OID, embedded device 45 may display the desired information (i.e., the system name “Joe's Range”). The information will be retrieved from device data 517 and formatted by MIB table 519 to be a text string displayable via the web browser of PC 35. However, if MIB table 519 does not contain the correlation between “sysName” and the OID, text box 52 will remain blank. Similarly, text box 54 will display the time that the system has been running. The MIB object relating to this device data 517 has an OID of 1.3.6.1.2.1.1.3. The common name for this MIB object is “sysUpTime” which will be used by the developer in programming web page 50.

As described above, each device (e.g., embedded device 45) may include hundreds of MIB objects and the system administrator or developer may not have included the correlation for “sysName” or “sysUpTime” in order to save memory resources. If the developer wants to use these common names, the developer needs a manner of inserting the correlation into MIB table 519 without recompiling the system. Additionally, new MIB objects may be added to the embedded device by, for example, SNMP console 500. The preferred embodiment according to the present invention allows the developer to dynamically add MIB object correlations to MIB table 519 objects so that the need to recompile each network device becomes unnecessary. The developer may then use any of the common names for the MIB objects when constructing web page 500.

The MIB object correlation may be added to MIB table 519 by including the correlation in the software code for the web page. The following shows an example of pseudo-HTML code for web page 50 implementing the dynamic addition of MIB objects to MIB table 519:

<“sysName”=OID 1.3.6.1.2.1.1.5>

<“sysUpTime”=OID 1.3.6.1.2.1.1.3>

<text box 55=pre-defined text>

<text box 51=pre-defined text>

<text box 53=pre-defined text>

<text box 52=“sysName”>

<text box 54=“sysUpTime”>

In this exemplary software code, the correlation between the common names “sysName”and “sysUpTime” are defined in the first two lines, respectively, of the software code for web page 50. This correlation definition may come in a header portion of the software code as in the exemplary code or in any other portion of the code before the common name is used. A reason to include the correlation definition in the header is that the common name may be used multiple times throughout the software code for the page. The next three lines of code define the three text boxes 55, 51 and 53 which have the pre-defined text. The following two lines of code, use the common names of the MIB objects to be displayed in text boxes 52 and 54. Since these common names have been defined previously in the software code, MIB table 519 will recognize the correlations and access the correct device data 517 related to the MIB objects for these common names.

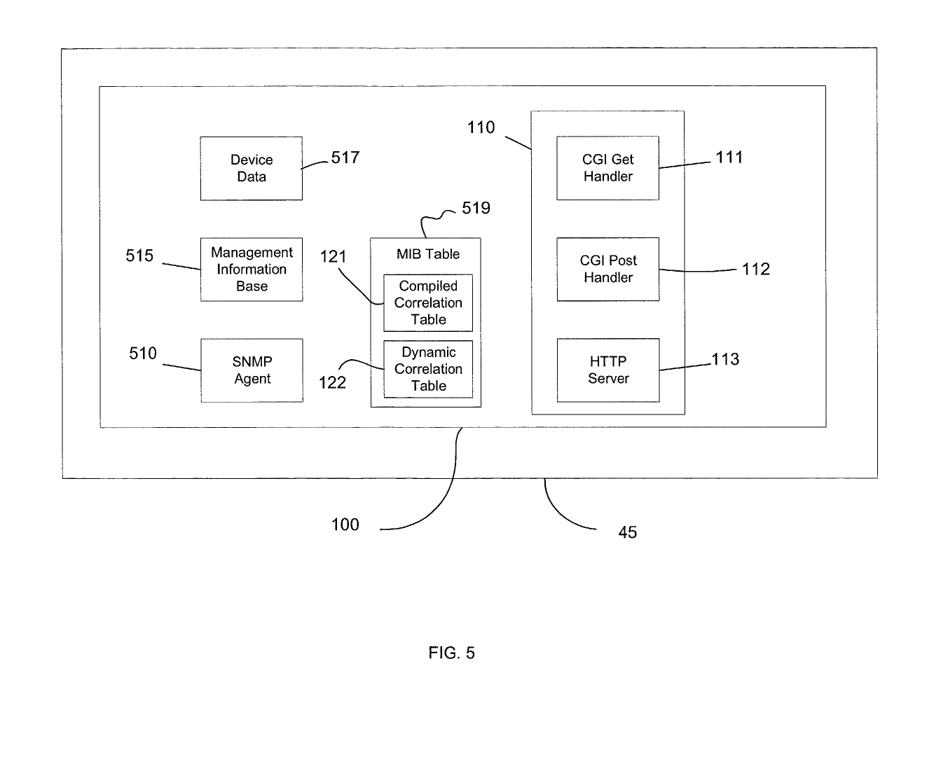

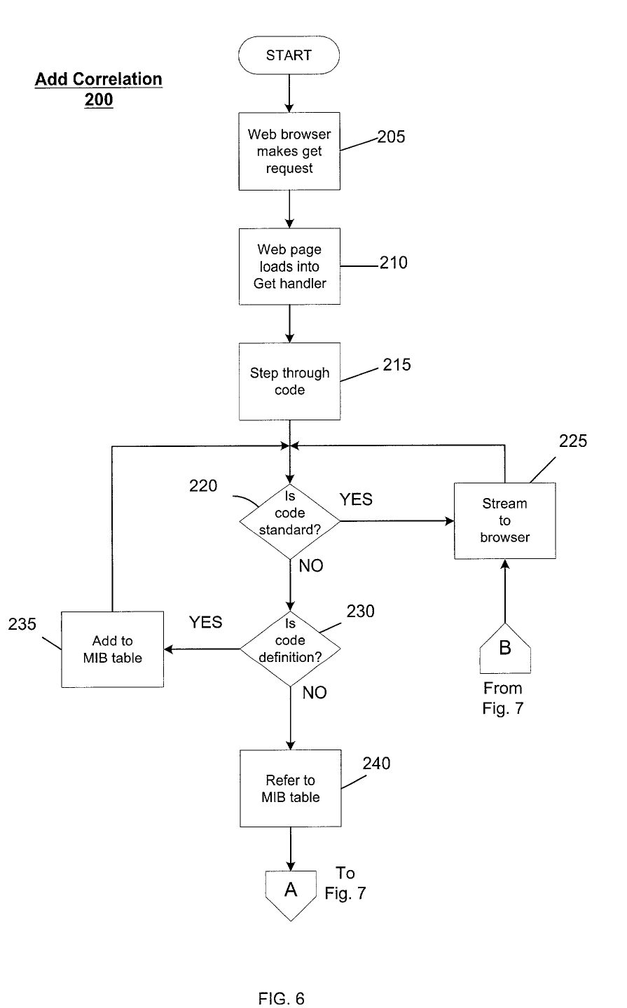

FIG. 5 shows an example of a software system 100 on embedded device 45 to implement the present invention. Software system 100 includes several modules previously described—device data 517, MIB 515, SNMP agent 510 and MIB table 519—and an additional module, web server 110. In this exemplary embodiment, MIB table 519 includes compiled correlation table 121 and dynamic correlation table 122. The compiled correlation table 121 contains the correlations which the developer or system administrator has chosen to include when the system software 100 was compiled. Dynamic correlation table 122 contains the correlations which may be added to MIB table 519 when the system software 100 is operating and does not require a recompiling of the system software 100. Web server 110 includes CGI Get Handler 111, CGI Post Handler 112 and HTTP 1.1/1.0 server 113. CGI handlers 111 and 112 are routines to execute the Common Gateway Interface (“CGI”) which is a standard approach to handling data exchanges between HTTP server 113 and ancillary programs. Those of skill in the art will understand that software system 100 is only exemplary and that embedded device 45 may include other software components such as an operating system. Additionally, web server 110 is also exemplary and may contain other features or operate using protocols other than CGI. The operation of software system 100 will be more fully described with respect to the processes described in FIGS. 6-8.

FIG. 6 is an exemplary process 200 for adding a MIB object correlation definition to MIB table 519. In step 205, an external web browser makes a request for web page 50 by, for example, requesting the uniform resource locator (“URL”) of web page 50. In step 210, web page 50 is then loaded into CGI Get handler 111 which begins stepping through the software code of web page 50 (e.g., HTML code) character-by-character in step 215. In step 220, CGI Get handler 111 determines if the software code is standard, and if the code is standard it is passed to HTTP server 113 and streamed out to the browser in step 225. The process then loops back to step 220 to check the next portion of code. If the CGI Get handler 111 in step 220 determines that the code is not standard, for example, a character combination is encountered which does not ordinarily appear in the software code (e.g., the character combination “$%” in HTML), the process continues to step 230.

In step 230, the CGI Get handler 111 determines whether the non-standard code is a MIB object correlation definition, for example, the first two lines of the pseudo code above. CGI Get handler 111 may distinguish between a MIB object correlation definition and a reference to a MIB object correlation by, for example, different leading character combinations. If the non-standard code is a MIB object correlation definition, the process continues to step 235 where the MIB object correlation definition is added to MIB table 519. The new MIB object correlation definition may be stored in dynamic correlation table 122 which may be, for example, an array or a table in system memory such that MIB table 519 has access to the MIB object correlation. Those skilled in the art will understand that dynamic correlation table 122 may be a separate memory location within embedded device 45 or may be an appendage to compiled correlation table 121 that contains the existing MIB object correlations that were compiled with the system.

The new MIB object correlation definition (in dynamic correlation table 122) may be temporarily (e.g., in random access memory (“RAM”)) or permanently stored (e.g., in flash memory) by dynamic correlation table 122. If the new MIB object correlation definition is stored permanently, it will always be available after the first time it has been defined. If the new MIB object correlation definition is only stored temporarily, it may be deleted from the system when web page 50 is fully streamed to the user, it may remain stored until web server 110 ends the current session or it may remain stored until the current thread is ended. For example, web page 50 may have links to other web pages also stored on embedded device 45, but web page 50 may contain all the required MIB object correlation definitions for all the web pages on embedded device 45 (i.e., there are no MIB object correlation definitions on any web pages except web page 50). Embedded device 45 may be initiated such that all users must enter embedded device 45 through web page 50, thus temporarily loading all the MIB object correlation definitions into MIB table 519. As the user steps through each of the web pages on embedded device 45, the MIB object correlations on the additional pages will have already been stored in MIB table 519. However, when the user exits the web pages associated with embedded device 45, the MIB object correlation definitions may be deleted to regain the memory space.

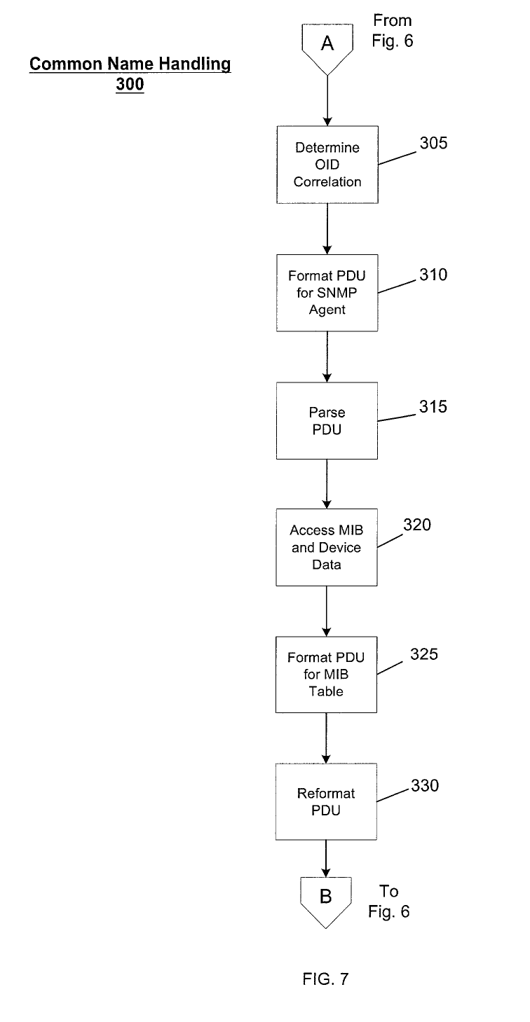

After step 235 is complete, the process then loops back to step 220 to check the next portion of code. If the code in step 330 is not a MIB object correlation definition, the CGI Get handler 111 makes the assumption that it is a reference to a common name for a MIB object and the process continues to step 240 where CGI Get handler 111 refers the common name to MIB table 519. This ends the exemplary process of FIG. 6, however, the process carried out by MIB table 519 after it receives the MIB object common name is more fully described with reference to FIG. 7. Those of skill in the art will understand that there may be other types of non-standard code in web page 50 and that CGI Get handler 111 may direct other types of non-standard code (i.e., code unrelated to MIB objects) to other portions of the software of embedded device 45. For example, in step 230 the nonstandard code may be neither of a reference to a common name for a MIB object or a MIB object correlation definition. In such a case, CGI Get handler 111 may direct such code to a different software module on embedded device 45 to handle the functionality associated with the other type of non-standard code.

FIG. 7is an exemplary process 300 for handling common names of MIB objects by MIB table 519. In step 305, MIB table 519 determines the correlation between the common name used in the code of web page 50 and the OID of the MIB object by, for example, the storage previously described. The MIB object correlation may be one that was originally stored in MIB table 519 when it was compiled (e.g., in compiled correlation table 121) or it may be a MIB object correlation that was defined in the code of web page 50 (e.g., stored in dynamic correlation table 122). Those of skill in the art will understand that it may be possible to leave compiled correlation table 121 blank at compile time and define MIB object correlations as needed. In step 310, MIB table 519 formats an internal PDU and passes it to SNMP agent 510. The internal PDU may then be parsed by SNMP agent 510 in step 315 and the MIB object may be accessed from MIB 515 along with the corresponding device data 517 in step 320. Once the information is accessed in step 320, SNMP agent 510 in step 325 may format a PDU containing the requested device data 517 and send it to MIB table 519. In step 330, MIB table 519 may receive this PDU and reformat it into, for example, text which is suitable for viewing via HTML, Wireless Markup Language (“WML”) or some other format that is compatible with the code that is being streamed out of the device. The process then reverts back to step 225 of FIG. 6, where the information is passed to HTTP server 113 and streamed out to the browser. As described above, it may also be possible to include logic in MIB table 519 so that it may access MIB 515 directly, bypassing SNMP agent 510.

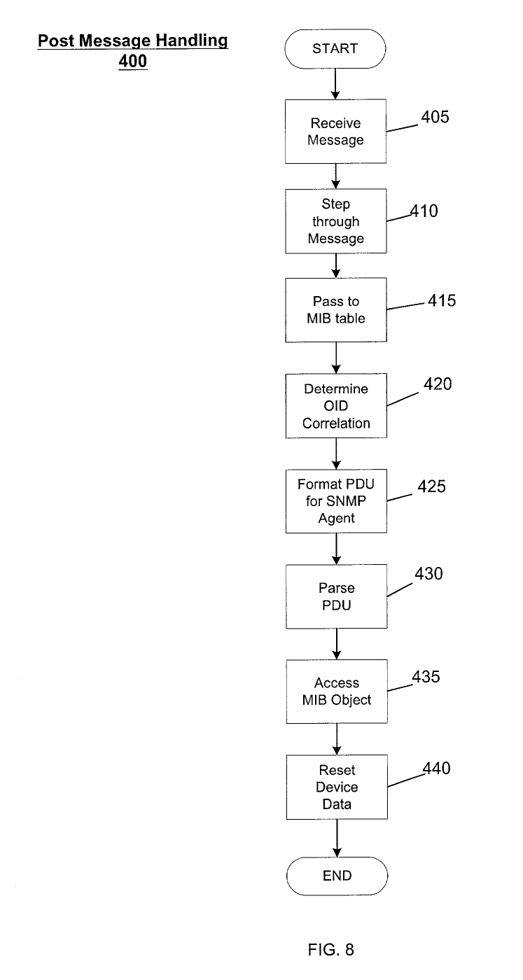

FIG. 8 is an exemplary process 400 for handling post operations on MIB objects from a user displaying web 50. As described above, when the device data 517 is displayed on web page 50, this device data may be changed by the user. For example, the user may desire to change the system name displayed in text box 52 from “Joe's Range” to “Mary's Range.” To make this change the user may, for example, highlight “Joe's Range” in the web browser, press delete and type in “Mary's Range” and then press the submit button. The web browser then sends back a message that may be referred to as an HTTP Post message to web server 110. The message may be in the following format:

&sysName=Mary's+Range&

In step 405 the message is received by HTTP server 113 and passed to CGI Post handler 112. Similar to CGI Get handler 111, CGI post handler 112 steps through the received message in step 410 and identifies the common name sysName and then passes the message to MIB table 519 in step 415. In step 420, MIB table 519 determines the correlation between the common name used in the message and the OID of the MIB object. The MIB object correlation may be one that was originally stored in MIB table 519 when it was compiled or it may be a MIB object correlation that was defined in the code of web page 50. In step 425, MIB table 519 formats an internal PDU and passes it to SNMP agent 510. The internal PDU may then be parsed by SNMP agent 510 in step 430 and the MIB object may be accessed from MIB 515 in step 435. In step 440, device data 517 for the system name is updated based on the message received from the user (e.g., “Mary's Range”). It should be noted that in the exemplary process of FIG. 7, the MIB object that is accessed is associated with the get routine for device data 517 resulting in the system getting the value for the desired device data 517. In the exemplary process of FIG. 8, the MIB object that is accessed is the set routine for device data 517 resulting in the system setting the value for the desired device data 517.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

1. A software package, comprising:
a variable describing a state of a device, the variable having an assigned name;
a mapping module including a mapping between the assigned name and a routine, wherein the routine accesses the variable; and
a dynamic receiving module receiving and storing, without recompiling the software package, a correlation between a common name for the variable and the assigned name, a request, including the common name of the variable being fulfilled by consulting the stored correlation.

2. The software package according to claim 1, wherein the variable is a Management Information Base object.

3. The software package according to claim 1, wherein the assigned name is an object identifier.

4. The software package according to claim 1, wherein the routine is one of a get routine and a set routine.

5. The software package according to claim 1, wherein the correlation is received from a application stored on the device.

6. The software package according to claim 1, wherein the correlation between the common name for the variable and the assigned name is stored in one of a temporary memory and a permanent memory of the device.

7. A method, comprising the steps of:
receiving a correlation between a common name and an assigned name for a variable, the variable describing a state of a device;
storing the correlation in one of a temporary and permanent memory of the device, the storing of the correlation being accomplished without compiling a software package on the device; and
storing a mapping between the assigned name and a routine, wherein the routine accesses the variable.

8. The method according to claim 7, further comprising the steps of:
receiving a request to access the variable, the request including the common name of the variable;
obtaining the assigned name by consulting the stored correlation;
obtaining the routine by consulting the mapping; and
accessing the variable using the routine.

9. The method according to claim 7, wherein the assigned name is an object identifier.

10. The method according to claim 7, wherein the routine is one of a set routine and a get routine.

11. The method according to claim 7, wherein the correlation is received from a application stored on the device.

12. The method according to claim 11, wherein the application is a web page.

13. A software package operating on a device, comprising:
a reading module to read software code in a file, the software code including a correlation between a common name and an assigned name for a variable; and
a dynamic correlation module receiving the correlation from the reading module and storing, without recompiling the software package, the correlation.

14. The software package according to claim 13, wherein the file is a web page.

15. The software package according to claim 13, wherein the software code includes a request to access the variable, the reading module forwarding the request to the dynamic correlation module which formats an updated request using the correlation.

16. The software package according to claim 13, wherein the variable is a management information base object and the assigned name is an object identifier.

17. The software package according to claim 13, further comprising:
a server module receiving the software code from the reading module and streaming the software code out of the device.

18. The software package according to claim 17, wherein the server module includes an HTTP server.

19. The software package according to claim 13, wherein the reading module includes a CGI get handler.

20. The software package according to claim 13, further comprising:
a post module receiving an additional request from outside the device to access the variable, the post module forwarding the request to the dynamic correlation module which formats an updated request using the correlation.

21. The software package according to claim 20, wherein the post module is a CGI post handler.

22. A method, comprising the steps of:
reading software code in a file, the software code including a correlation between a common name and an assigned name for a variable, the variable describing a state of a device;
and
dynamically storing the correlation in one of permanent memory and temporary memory, without compiling a software system on the device.

23. The method according to claim 22, further comprising the steps of receiving a request to access the variable, the request including the common name of the variable; and
reformatting the request using the dynamically stored correlation.
